(19) United States
(12) Patent Application Publication
(10) Pub. No.: US 2009/0208895 A1
(43) Pub. Date: Aug. 20, 2009

(54) PLASTER DENTAL CAST GUM PLATE MOLDING MOLD

(76) Inventor: Chao-Hung LIN, Taipei City (TW)

Correspondence Address: SINORICA, LLC, 2275 Research Blvd., Suite 500, ROCKVILLE, MD, 20850, US

(21) Appl. No.: 12/032,684

(22) Filed: Feb. 17, 2008

(51) Int. Cl. A61C 13/20

(52) U.S. Cl. 433/34

(57) ABSTRACT

A plaster dental cast gum plate molding mold for molding a plaster dental cast gum plate having pins is disclosed. The body of the mold is made of an elastic material, having a cavity surrounded by a smoothly arched inner wall, a smoothly arched outer wall and a bottom wall, a plurality of insertion holes cut through the bottom wall for the insertion of a respective pin, and a plurality of alignment pegs respectively perpendicularly extending from the smoothly arched outer wall and suspending in the cavity so that the molded plaster cast gum plate has dents corresponding to the alignment pegs for quick recognition of the locations of the pins after positioning of the plaster cast gum plate on a base plate and bonding of a dental cast to the flat top surface of the plaster cast gum plate for enabling the dentist to cut one individual tooth model accurately.

### BACKGROUND OF THE INVENTION

1. Field of the Invention

The present invention relates to a molding tool and more specifically, to a plaster dental cast gum plate molding mold.

2. Description of the Related Art

The fabrication of a denture requires high precision so that the patient can bite smoothly after the installation of the denture. Therefore, a plaster tooth model is necessary for test and modification to ensure smooth biting after installation of the denture.

Conventionally, the preparation of a plaster dental cast for use in making a denture or false tooth is complicated. A plaster dental cast has pins for positioning on a base plate, and can be cut to separate one selected individual tooth model.

Further, during preparation of a plaster dental cast, the prepared plaster is poured into the mold to fill up the whole space of the cavity. It is necessary to mold a plaster dental cast corresponding to the whole configuration of the teeth even if only a partial plaster dental cast is required. This method wastes a lot of the material.

Further, commercial plaster dental cast molding molds cannot be used to make a full set of plaster dental cast that has pins for positioning. Conventional plaster dental cast preparation methods are commonly complicated. If there is any small error in either step during the preparation of the plaster dental cast, the finished denture will be unable to fit the remaining teeth perfectly, causing the patient to feel uncomfortable. Further, a defective denture cannot be used again, wasting the resource and increasing the cost.

Therefore, it is desirable to provide a mold that eliminates the aforesaid problems.

### SUMMARY OF THE INVENTION

The present invention has been accomplished under the circumstances in view. It is the main object of the present invention to provide a plaster dental cast gum plate molding mold, which simplifies the preparation of a dental cast, and effectively reduces the error rate.

According to one aspect of the present invention, the plaster dental cast gum plate molding mold comprises a smoothly arched inner wall, a smoothly arched outer wall, a bottom wall connected between the smoothly arched inner wall and the smoothly arched outer wall, and a cavity surrounded by the smoothly arched inner wall, the smoothly arched outer wall and the bottom wall. The prepared plaster is filled into the cavity. After the plaster is hardened, the molded plaster dental cast gum plate has the configuration of the oral cavity.

According to another aspect of the present invention, the plaster dental cast gum plate molding mold is made out of an elastic material to facilitate removal of the molded plaster dental cast gum plate. Further, the body has a plurality of alignment pegs perpendicularly extending from the smoothly arched outer wall and suspending in the cavity corresponding to the insertion holes on the bottom wall. After molding of a plaster dental cast gum plate, the plaster dental cast gum plate has dents for quick recognition of the locations of the pins to facilitate accurate cutting of the plaster dental cast.

According to still another aspect of the present invention, the body further comprises a plurality of axial locating blocks provided at the bottom wall and respectively connected to the smoothly arched inner wall so that the molded plaster dental cast gum plate is configured for quick positioning on a plaster base plate to constitute a complete dental cast. The body further comprises a smoothly arched rib upwardly protruded from the bottom wall and extending around the smoothly arched inner wall. The axial locating blocks are respectively connected between the smoothly arched rib and the smoothly arched inner wall.

According to still another aspect of the present invention, the body further comprises a plurality of overflow holes located on the smoothly arched outer wall. After filling of the prepared plaster in the cavity, the plaster is leveled. During leveling of the plaster, the excessive amount of the plaster is expelled out of the cavity through the overflow holes. The leveled flat surface of the plaster dental cast gum plate thus molded is provided for the bonding of a plaster dental cast.

According to still another aspect of the present invention, the plaster dental cast gum plate molding mold further comprises an insert for insertion into the cavity to occupy the space where the filling of the plaster is not necessary, thereby saving much the consumption of the plaster.

According to still another aspect of the present invention, the body has an opening surrounded by the smoothly arched inner wall to enhance the amount of deformation of the body during stripping of the molded plaster dental cast gum plate.

### BRIEF DESCRIPTION OF THE DRAWINGS

FIG. 1 is an elevational view of a plaster dental cast gum plate molding mold in accordance with the present invention.

FIG. 2 is a top view of the plaster dental cast gum plate molding mold in accordance with the present invention.

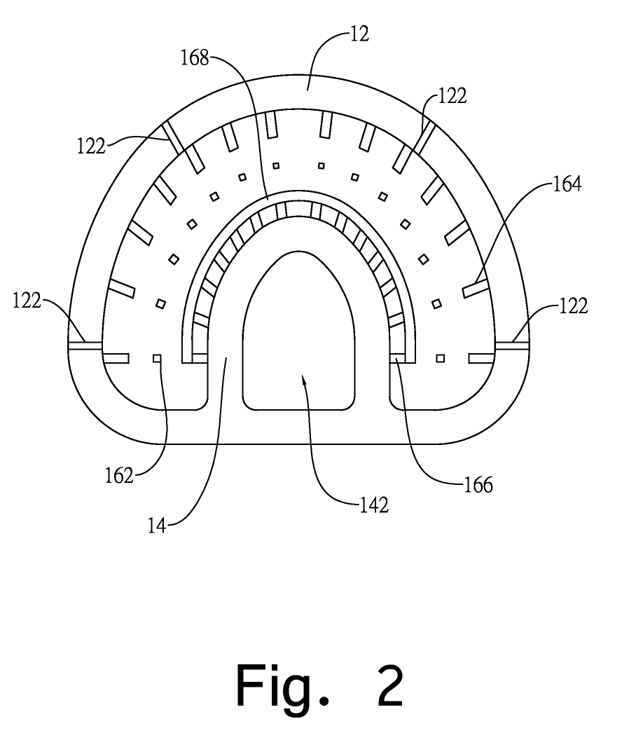

FIG. 3 is a sectional view of the plaster dental cast gum plate molding mold in accordance with the present invention.

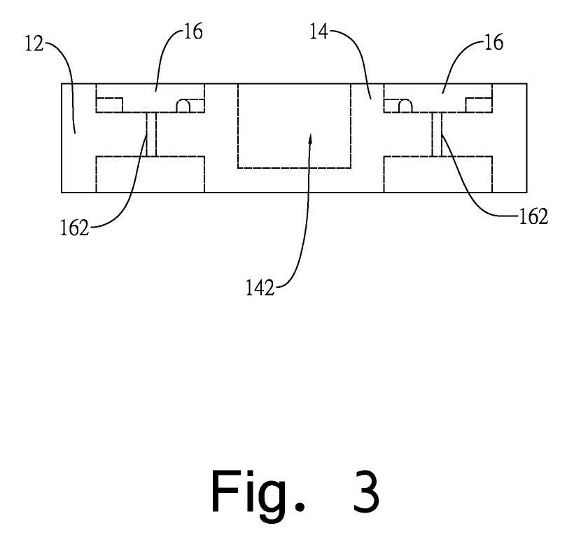

FIG. 4 is a bottom view of the plaster dental cast gum plate molding mold in accordance with the present invention.

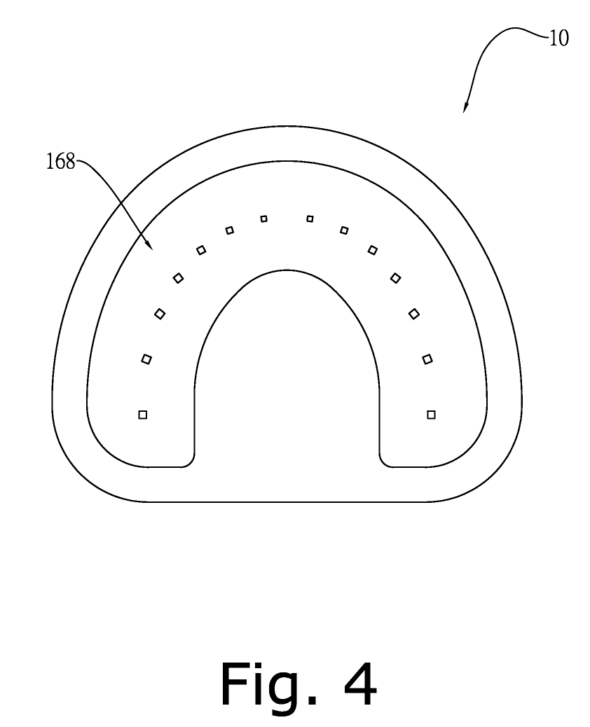

FIG. 5 is an oblique top elevation of an insert of the plaster dental cast gum plate molding mold in accordance with the present invention.

FIG. 6 an oblique bottom elevation of the insert shown in FIG. 5.

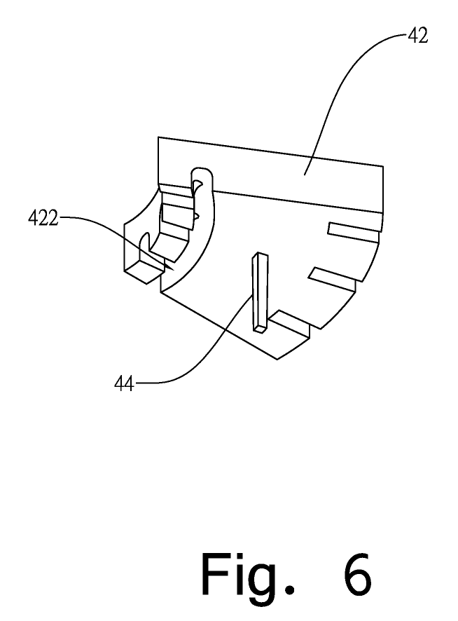

FIG. 7 is a schematic drawing showing the relation ship between the insert and the body of the plaster dental cast gum plate molding mold in accordance with the present invention.

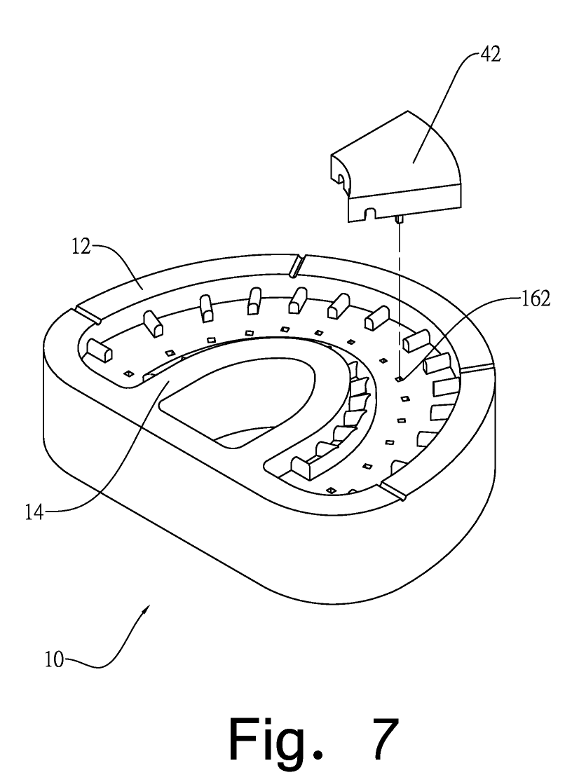

FIG. 8 corresponds to FIG. 7, showing the insert inserted into the cavity of the body.

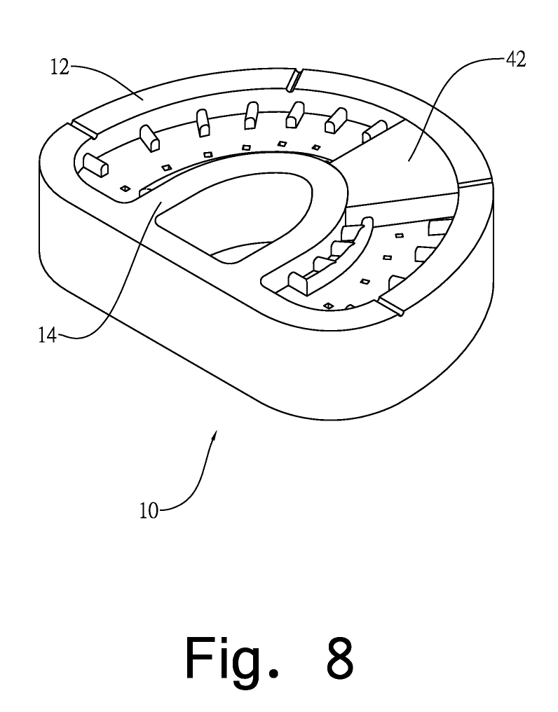

FIG. 9 is an elevational view of a plaster dental cast gum plate molded from FIG. 8.

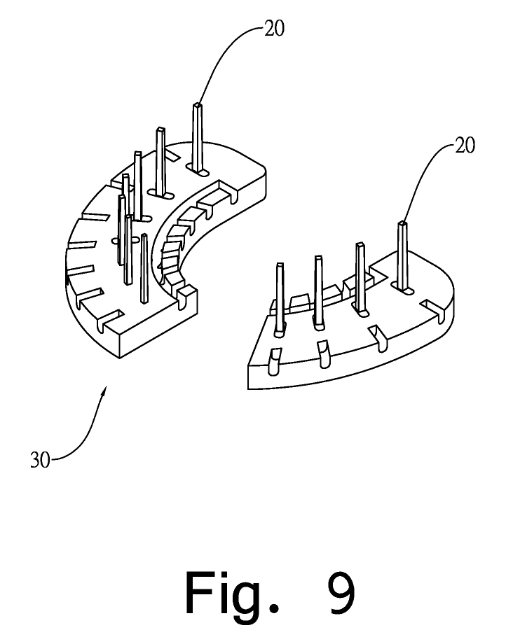

FIG. 10 is a schematic drawing showing the relationship between pins and the insertion holes of the body of the plaster dental cast gum plate molding mold in accordance with the present invention.

FIG. 11 corresponds to FIG. 10, showing the pins respectively inserted into the insertion holes of the body of the plaster dental cast gum plate molding mold.

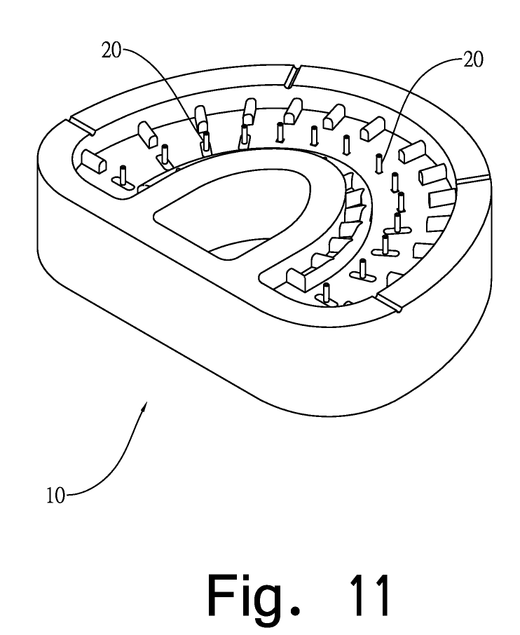

FIG. 12 is an elevational view of a molded plaster dental case gum plate according to the present invention.

FIG. 13 is a schematic drawing showing a tooth model cut from a complete plaster dental cast according to the present invention.

### DETAILED DESCRIPTION OF THE PREFERRED EMBODIMENT

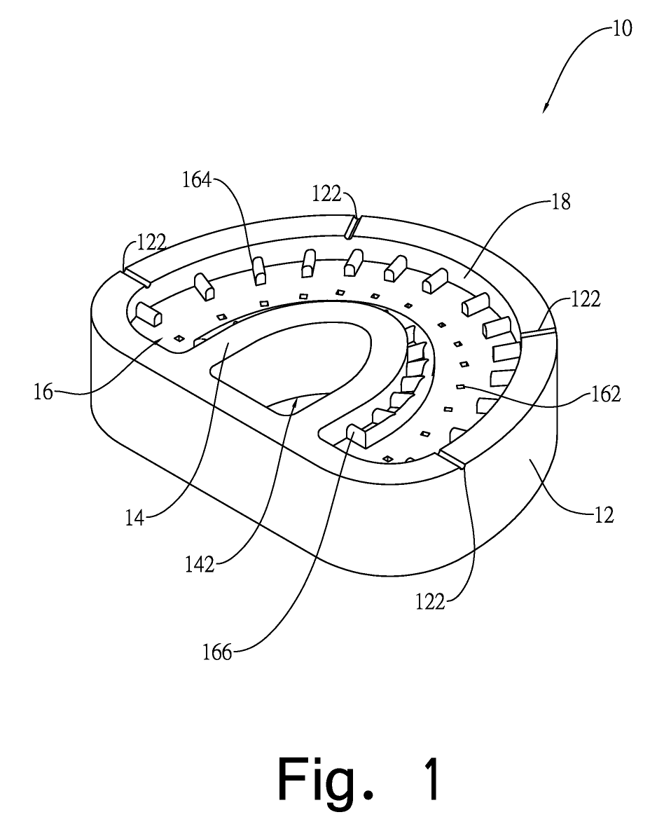

Referring to FIGS. 1˜3, a plaster dental cast gum plate molding mold in accordance with the present invention is shown comprising a body 10. The body 10 comprises a smoothly arched outer wall 12, a smoothly arched inner wall 14, a bottom wall 16, and a cavity 18. The body 10 is made out of an elastic material. The cavity 18 is surrounded by the smoothly arched outer wall 12, the smoothly arched inner wall 14 and the bottom wall 16, and adapted for receiving gypsum. Further, the bottom wall 16 has a plurality of insertion holes 162 and alignment pegs 164. The insertion holes 162 are arranged in a line on the bottom wall 16 between the smoothly arched outer wall 12 and the smoothly arched inner wall 14 for the insertion of pins 20. The insertion holes 162 on the middle part between the smoothly arched outer wall 12 and the smoothly arched inner wall 14 have a diameter relatively smaller than the insertion holes 162 at the two distal ends between the smoothly arched outer wall 12 and the smoothly arched inner wall 14. A plaster dental cast gum plate thus obtained is positioned on a base plate and bonded with a plaster dental cast so that the dentist can cut one single tooth model from the bonded plaster dental cast and plaster dental cast gum plate. The invention is characterized in the smoothly arched design of the cavity 16 that is surrounded by the smoothly arched outer wall 12 and the smoothly arched inner wall 14 and the arrangement in which the insertion holes 162 on the middle part of the cavity 16 between the smoothly arched outer wall 12 and the smoothly arched inner wall 14 have a diameter relatively smaller than the insertion holes 162 at the two distal ends of the cavity 16 between the smoothly arched outer wall 12 and the smoothly arched inner wall 14. These features match the arrangement and configurations of the teeth.

The alignment pegs 164 are respectively perpendicularly extending from the smoothly arched outer wall 12 and suspending in the cavity 18 corresponding to the insertion holes 162. The body 10 further comprises a plurality of axial locating blocks 166 provided at the bottom wall 16 and respectively connected to the smoothly arched inner wall 14.

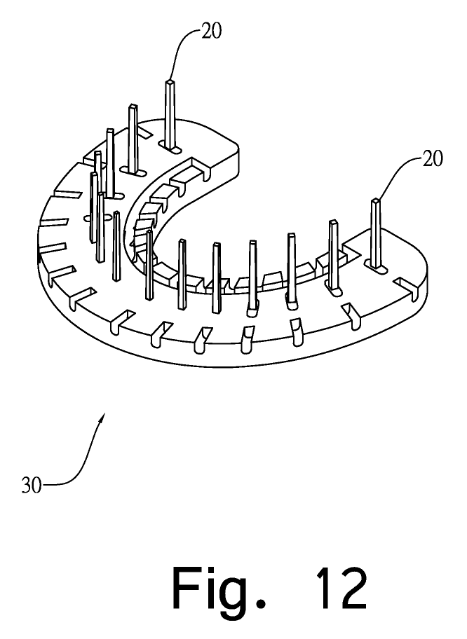

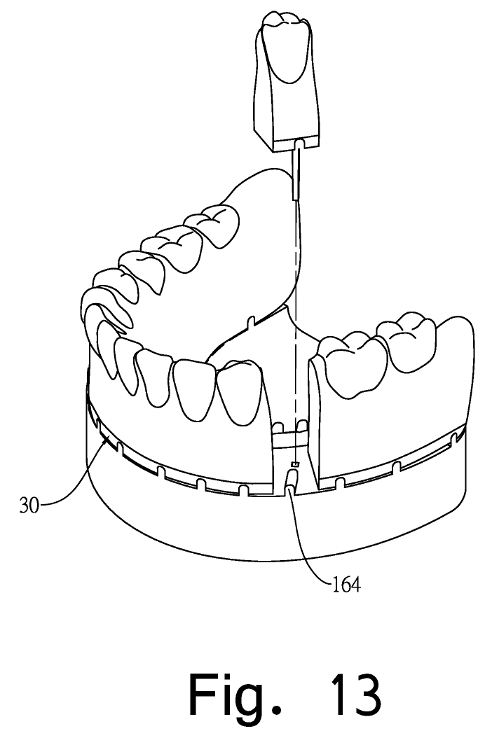

Referring to FIGS. 12 and 13 and FIG. 1 again, after molding of the plaster in the cavity 16 of the body 10, the plaster dental cast gum plate 30 has dents 32 corresponding to the alignment pegs 164. By means of the dents 32, the user can easily recognize the positions of the pins 20 when dividing one single tooth form from the plaster dental cast that is supported on the plaster dental cast gum plate 30.

The body 10 further comprises a smoothly arched rib 168 upwardly protruded from the bottom wall 16 and extending around the smoothly arched inner wall 14. The aforesaid axial locating blocks 166 are respectively connected between the smoothly arched inner wall 14 and the smoothly arched rib 168.

The body 10 further comprises a plurality of overflow holes 122 located on the smoothly arched outer wall 12. After filling of plaster in the cavity 16, the plaster is leveled. During leveling of the plaster, the excessive amount of the plaster is expelled out of the cavity 15 through the overflow holes 122.

Further, the smoothly arched inner wall 14 define an opening 142 that facilitates deformation of the body 10 so that the molded plaster dental cast gum plate 30 can easily be removed from the body 10.

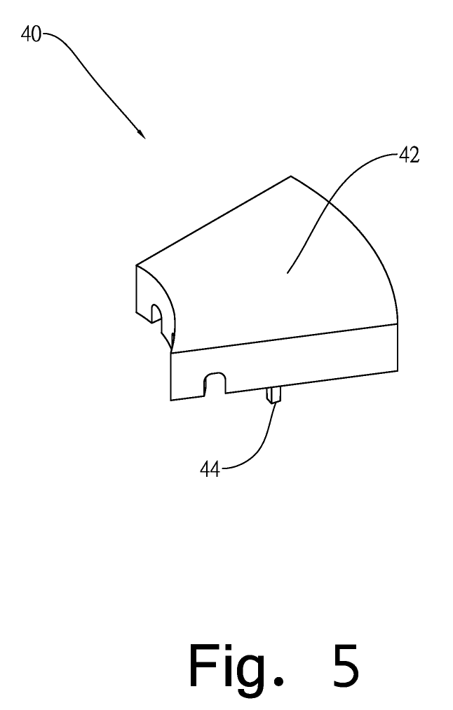

Referring to FIGS. 5˜8, the invention further comprises an insert 40. The insert 40 comprises a block 42 and at least one pin 44 perpendicularly extending from the bottom wall of the block 42. The block 42 is configured to fit a part of the cavity 16 of the body 10, having a groove 422 that fits a part of the configuration of the axial locating blocks 166 and smoothly arched rib 168. The insert 40 is inserted into the cavity 18 to occupy the space where the filling of the plaster is not necessary. By means of inserting the pin 44 of the insert 40 into the selected insertion hole 162, the block 42 is firmly fitted into the cavity 16 to occupy the space not to be filled with the plaster. Thereafter, the user fills the plaster into the cavity 16 at two sides of the insert 40. After molding, two separated plaster dental cast gum plates 30 are obtained.

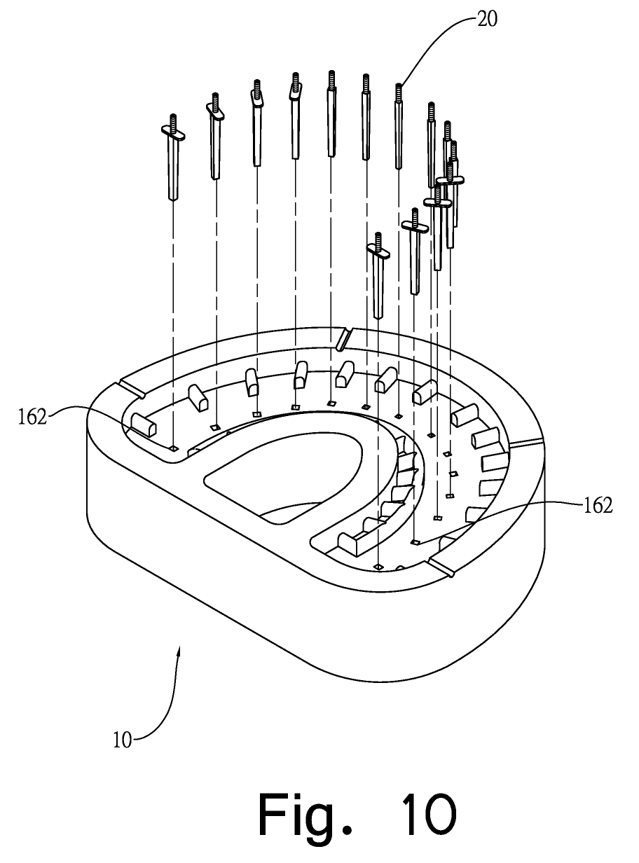

Referring to FIGS. 10˜13, pins 20 are respectively inserted into the insertion holes 162 in the cavity 16 of the body 10, and then the prepared plaster is filled into the cavity 16. When the plaster is hardened, a plaster dental cast gum plate 30 is obtained. The plaster dental cast gum plate 30 thus obtained has a plurality of pins 20 perpendicularly extending out of its one side, and a plurality of dents 32 arranged along the periphery corresponding to the pins 20. After bonding of a dental cast to the flat top surface of the plaster dental cast gum plate 30, the pins 20 of the plaster dental cast gum plate 30 are fastened to a plaster base plate, forming a complete dental cast. Further, the dentist can cut one single tooth model from the dental cast thus obtained accurately subject to the indication of the dent 32.

Although a particular embodiment of the invention has been described in detail for purposes of illustration, various modifications and enhancements may be made without departing from the spirit and scope of the invention.

What the invention claimed is:

1. A plaster dental cast gum plate molding mold comprising a body made of an elastic material, said body comprising a smoothly arched inner wall, a smoothly arched outer wall, a bottom wall connected between said smoothly arched inner wall and said smoothly arched outer wall, a cavity surrounded by said bottom wall for molding a plaster dental cast gum plate, said smoothly arched inner wall and said smoothly arched outer wall, a plurality of insertion holes cut through said bottom wall and arranged in a line and equally spaced between said smoothly arched inner wall and said smoothly arched outer wall for the insertion of a respective pin, and a plurality of alignment pegs respectively perpendicularly extending from said smoothly arched outer wall and suspending in said cavity corresponding to said insertion holes.

2. The plaster dental cast gum plate molding mold as claimed in claim 1, wherein said body further comprises a plurality of axial locating blocks provided at said bottom wall and respectively connected to said smoothly arched inner wall.

3. The plaster dental cast gum plate molding mold as claimed in claim 2, wherein said body further comprises a smoothly arched rib upwardly protruded from said bottom wall and extending around said smoothly arched inner wall; said axial locating blocks are respectively connected between said smoothly arched inner wall and said smoothly arched rib.

4. The plaster dental cast gum plate molding mold as claimed in claim 1, wherein said smoothly arched outer wall has at least one overflow hole.

5. The plaster dental cast gum plate molding mold as claimed in claim 4, further comprising an insert, said insert comprising a block fitted into a part of said cavity and at least one pin perpendicularly extending from a bottom side of said block for insertion into said insertion holes of said body, said block having a groove configured to fit the configuration of said axial locating blocks and said smoothly arched rib.

6. The plaster dental cast gum plate molding mold as claimed in claim 5, wherein said body comprising an opening surrounded by said smoothly arched inner wall.

7. The plaster dental cast gum plate molding mold as claimed in claim 1, the insertion holes on a middle part of said cavity between said smoothly arched outer wall and said smoothly arched inner wall have a diameter relatively smaller than the insertion holes at two distal ends of said cavity between said smoothly arched outer wall and said smoothly arched inner wall.
